(19) United States
(12) Patent Application Publication
(10) Pub. No.: US 2012/0144454 A1
(43) Pub. Date: Jun. 7, 2012

(54) APPARATUS FOR MANAGING AUTHORIZATION IN SOFTWARE-AS-A-SERVICE PLATFORM AND METHOD FOR THE SAME

(75) Inventor: Won Jae Lee, Daejeon (KR)

(73) Assignee: ELECTONICS AND TELECOMMUNICATIONS RESEARCH INSTITUTE, Daejeon (KR)

(21) Appl. No.: 13/292,581

(22) Filed: Nov. 9, 2011

(30) Foreign Application Priority Data
Dec. 6, 2010 (KR) 10-2010-0123807

(51) Int. Cl. G06F 21/00; G06F 7/04

(52) U.S. Cl. 726/4; 726/3

(57) ABSTRACT

An authorization management apparatus and method in a software-as-a-service (SaaS) platform is disclosed. The present invention provides an automated authorization management apparatus and method which can efficiently reduce errors by applying a basic authority of a virtual tenant, which is predefined for an application to be provided to a tenant, as it is to the tenant requesting the use of the application. Moreover, the present invention provides an authorization management apparatus and method which can provide services customized to various tenants by defining a role appropriate for the condition of each tenant and allocating an application resource for each role. The authorization management apparatus includes a user application access control device, an access control device for a user's resource, a virtual tenant authority definition device, and a tenant authority definition device.

### CROSS-REFERENCE TO RELATED PATENT APPLICATION

This application claims the benefit of Korean Patent Application No. 10-2010-0123807, filed on Dec. 6, 2010, in the Korean Intellectual Property Office, the disclosure of which is incorporated herein in its entirety by reference.

### BACKGROUND OF THE INVENTION

1. Field of the Invention

The present invention relates to an authorization management apparatus and method for an application provided in a software-as-a-service (SaaS) platform and, more particularly, to an authorization management apparatus and method, which can support multiple tenants.

2. Description of the Related Art

With the increase in costs for developing and maintain an information system, the number of enterprises that outsource their businesses to third parties, i.e., application service providers, have increased. For example, the application service providers develop various applications related to various businesses of enterprises in the form of software and provide the applications to the enterprises. The enterprises receiving the applications from professional service providers can reduce the cost and inefficiency caused by directly managing several application systems. Meanwhile, the service providers have to support various sized enterprises that want to receive the services and their different requirements.

Software-as-a-service (SaaS) has been developed to meet the requirements. The SaaS is a software distribution model, which selectively provides functions required by an enterprise, and is also called “service type software”. The enterprise can use only the necessary functions and pay only for the functions used.

That is, while one software includes comprehensive functions to accommodate as many enterprises as possible, an enterprise that desires to use the software can select necessary functions and do not have to pay for the unselected functions. Therefore, with the intention of providing a customized service that meets the requirements of each of various enterprises, the SaaS is similar to an existing application service provider (ASP) service in that the SaaS provides software through a network, but the SaaS has the advantage of customizing the software to be more suitable for the enterprise. That is, the SaaS can customize a user interface, business logic, database schema, etc. appropriately for each enterprise, which is the feature of the SaaS.

Unlike an existing software service which allocates a different server to each enterprise, a SaaS-based system provides services to many enterprises using one server and also supports various types of applications. However, much time and effort is required to allocate the application functions to each enterprise in such an environment.

For example, in a situation where the functions and data used by all enterprises are included in a common database, when the functions or resources required to meet the demand of each enterprise are individually allocated and defined based on an access authority of a person belonging to the enterprise, many errors and reworks occur, which result in a loss of time and resources.

### SUMMARY OF THE INVENTION

The present invention has been made in an effort to solve the above-described problems associated with prior art, and an object of the present invention is to provide an authorization management apparatus for providing various application services to many enterprises in a software-as-a-service (SaaS) platform, which can reduce the loss of time and resources required to customize the authority to access the application for each enterprise.

Another object of the present invention is to provide an authorization management method for providing various application services to many enterprises in a software-as-a-service (SaaS) platform, which can reduce the loss of time and resources required to customize the authority to access the application for each enterprise.

According to an aspect of the present invention to achieve the above object of the present invention, there is provided an application access control device for a software-as-a-service (SaaS), the device comprising: an application access request reception unit which receives a request for access to an application from a user belonging to one tenant; a tenant authority storage unit in which a tenant authority for an application is defined, the tenant authority including roles and resources accessible for each role; an access permission determination unit which determines whether to permit the access by referring to the tenant authority storage unit to identify an authority of the tenant, to whom the user requesting the access to the application belongs, with respect to the requested application; a user authority storage unit which stores authority information including the roles of users belonging to each tenant with respect to the application; and an access permission unit which permits the user, who is permitted to access, to access the requested application by referring to the user authority storage unit.

The access permission unit may comprise: a role identification unit which identifies the role of the user, who is permitted to access the requested application, by referring to the user authority storage unit; an accessible resource identification unit which identify accessible resources based on the identified role of the user by referring to the tenant authority storage unit; and a resource display unit which displays a list of the identified accessible resources through a user interface.

According to another aspect of the present invention to achieve the above object of the present invention, there is provided a resource access control device for a software-as-a-service (SaaS), the device comprising: a resource access request reception unit which receives a request for access to an application resource from a user belonging to one tenant; a user authority storage unit which stores authority information including roles of users belonging to each tenant with respect to the application; a tenant authority storage unit in which a tenant authority for the application is defined, the tenant authority including roles and resources accessible for each role; a resource access authority identification unit which identifies whether the user has an authority to access the requested application resource by referring to the user authority storage unit and the tenant authority storage unit; and a resource access determination unit which determines the access to the requested resource with respect to the user whose access authority is identified.

The resource access determination unit may comprise: an application information storage unit which stores basic information on the application and information on at least one resource belonging to the application; a resource access permission unit which permits the user, whose access authority is identified, to access the resource; and a user interface provider which obtains information on the resource requested to be accessed by referring to the application information storage unit and provides an interface to the user who is permitted to access the resource.

According to still another aspect of the present invention to achieve the above object of the present invention, there is provided a virtual tenant authority definition device for a software-as-a-service (SaaS), the device comprising: an application registration request reception unit which receives a request for registration of an application to be provided to a tenant; an application information storage unit which stores information on the application; a virtual tenant authority storage unit which stores information on a virtual tenant's authority to use the application; an application information definition unit which defines information on the application requested to be registered and stores the defined information in the application information storage unit; and a virtual tenant authority definition unit which allocates an authority to use the application, whose information is defined, to the virtual tenant and stores the authority to use the application in the virtual tenant authority storage unit.

The application information stored in the application information storage unit may comprise basic information on the application, at least one application resource belonging to the application, and basic information on the application resource.

The virtual tenant’ authority to use the application, stored in the virtual tenant authority storage unit, may comprise at least one role, which belongs to the virtual tenant, with respect to the application whose information is defined and at least one resource accessible by the role.

The virtual tenant authority definition unit may comprise: a virtual tenant generation unit which generates any virtual tenant to give a basic authority to the application whose information is defined; a role definition unit which defines at least one role belonging to the generated virtual tenant and stores the defined role in the virtual tenant authority storage unit; and a resource allocation unit which defines at least one resource belonging to the application whose information is defined such that the resource is accessible by the defined role and stores the defined resource in the virtual tenant authority storage unit.

According to yet another aspect of the present invention to achieve the above object of the present invention, there is provided a tenant authority definition device for a software-as-a-service (SaaS), the device comprising: an application use request reception unit which receives a request for use of an application from a tenant; a virtual tenant authority storage unit which stores authority information of a virtual tenant with respect to the application; a tenant authority storage unit which stores authority information of the tenant requesting the use of the application; and a tenant authority allocation unit which copies the authority information of the virtual tenant, which is stored in the virtual tenant authority storage unit, with respect to the requested application as authority information of the tenant requesting the use of the application and stores the authority information in the tenant authority storage unit.

The tenant authority definition device may further comprise: a user authority storage unit which stores authority information of users belonging to the tenant requesting the use of the application; and a user authority allocation unit which refers to the authority information of the tenant requesting the use of the application and the authority information of the users stored in the user authority storage unit and allocates an authority to use the requested application to the users belonging to the tenant requesting the use of the application.

The authority information of the virtual tenant stored in the virtual tenant authority storage unit may comprise at least one role, which belongs to the virtual tenant, with respect to the application requested to be used and at least one resource accessible by the role, the authority information of the tenant requesting the use of the application stored in the tenant authority storage unit may comprise at least one role, which belongs to the tenant requesting the use of the application, with respect to the application requested to be used and at least one resource accessible by the role, and the authority information of the user stored in the user authority storage unit may comprise information defining basic roles of the users belonging to the tenant requesting the use of the application and a role of the requested application.

The user authority allocation unit may define the roles of the users with respect to the requested application based on the basic roles of the users belonging to the tenant requesting the use of the application stored in the user authority storage unit and store the defined roles in the user authority storage unit.

The roles of the users with respect to the requested application can be redefined differently.

The authority information of the virtual tenant copied to the tenant authority storage unit can be redefined.

According to still yet another aspect of the present invention to achieve the above object of the present invention, there is provided a method of defining a virtual tenant authority implemented by a virtual tenant authority definition device for a software-as-a-service (SaaS), the method comprising: receiving a request for registration of an application to be provided to a tenant; defining information on the application requested to be registered; and allocating an authority to use the application, whose information is defined, to a virtual tenant.

The application information may comprise basic information on the application, at least one application resource belonging to the application, and basic information on the application resource.

The virtual tenant’ authority to use the application may comprise at least one role, which belongs to the virtual tenant, with respect to the application whose information is defined and at least one resource accessible by the role.

According to a further aspect of the present invention to achieve the above object of the present invention, there is provided a method of defining a tenant authority implemented by a tenant authority definition device for a software-as-a-service (SaaS), the method comprising: receiving a request for use of an application from a tenant; allocating predefined authority information of a virtual tenant to authority information of the tenant requesting the use of the application as it is; and allocating an authority to use the requested application to users belonging to the tenant requesting the use of the application by referring to the allocated authority information of the tenant requesting the use of the application and information of the users belonging to the tenant requesting the use of the application.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing a device for controlling a user's access to an application in accordance with an embodiment of the present invention;

FIG. 2 is a sequence chart showing a process of controlling a user's access to an application in accordance with an exemplary embodiment of the present invention;

FIG. 3 is a block diagram showing a device for controlling a user's access to an application resource in accordance with an exemplary embodiment of the present invention;

FIG. 4 is a sequence chart showing a process of controlling a user's access to an application resource in accordance with an exemplary embodiment of the present invention;

FIG. 5 is a block diagram of a device for defining a virtual tenant authority in accordance with an exemplary embodiment of the present invention;

FIG. 6 is a conceptual diagram showing the structure of an application information storage unit in accordance with an exemplary embodiment of the present invention;

FIG. 7 is a conceptual diagram showing the structure of a virtual tenant authority storage unit in accordance with an exemplary embodiment of the present invention;

FIG. 8 is a sequence chart showing a process of defining a virtual tenant authority in accordance with an exemplary embodiment of the present invention;

FIG. 9 is a block diagram showing a tenant authority definition device for defining an authority of a tenant requesting the use of an application in accordance with an exemplary embodiment of the present invention;

FIG. 10 is a conceptual diagram showing the structure of a tenant authority storage unit in accordance with an exemplary embodiment of the present invention;

FIG. 11 is a conceptual diagram showing the structure of a user authority storage unit in accordance with an exemplary embodiment of the present invention; and

FIG. 12 is a sequence chart showing a process of defining a tenant's authority to use an application in accordance with an exemplary embodiment of the present invention.

### DETAILED DESCRIPTION OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B etc. may be used herein to describe various elements, these elements should not be limited by these terms. These terms are only used to distinguish one element from another. For example, a first element could be termed a second element, and similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings. Like reference numerals in the drawings denote like elements, and thus repeated descriptions will be omitted.

The present invention discloses an authorization management system for providing a variety of applications to many tenants, i.e., many enterprises, in a software-as-a-service (SaaS) platform, which can provide an application use environment appropriate for the environment and requirements of each enterprise.

In particular, the present invention discloses an apparatus capable of performing authorization management individually for each tenant with respect to the same application by grating roles appropriate for the unique environment of each tenant to the tenant and defining a unique authority for each role.

Moreover, the present invention discloses an authority definition device, in which a concept of a virtual tenant, which is a kind of authority template, is introduced to predefine roles for an application and a basic authority for each role with respect to the virtual tenant, thereby defining the authority to access the application with respect to each tenant based on the basic role of the virtual tenant by an automated process.

The term “tenant” used in the present invention may include an individual enterprise, a small-sized group with a certain purpose, a company-wide enterprise including various affiliated companies, a group of individuals, etc. The term “application” used in the present invention may include all applications, which can be accessed and managed via a network, such as an application for supporting the business of a person, a group or a company, an application for supporting external activities, etc.

A storage unit mentioned in the exemplary embodiment of the present invention includes all types of storage spaces and data management systems such as a database management system, a file system, etc. having various data management functions to store, read and write data in a certain form.

A user role is taken as an example of the role mentioned in the exemplary embodiment of the present invention, and menu items (such as a board reference, etc.) or URL selectable from a user interface and provided by a corresponding application are taken as examples of resources. However, these can be more variously defined according to the type and characteristics of the application or tenant within the spirit of the present invention.

Next, with regard to the authorization management system in the SaaS platform in accordance with the present invention, the configuration of an access control device, which handles requests for access to an application from users based on the authority defined to a tenant to whom the users belong, will be described. Moreover, the configuration of a tenant authority storage unit and a user authority storage unit, which constitute the access control device, will be described.

Configuration and Operation of User Access Control Device

A user access control process may include two steps, i.e., an application access request step and an application resource access request step by a user. In an exemplary embodiment of the present invention, the resources which are allowed to be accessed are different for each user role even in the same application, and thus the description will be given by dividing the user access control into the two steps.

However, the control process may be divided based on the type of the interface provided to the user or may be integrated into one step. Otherwise, the two steps may be connected through the interface.

(1) Configuration and Operation of Application Access Control Device

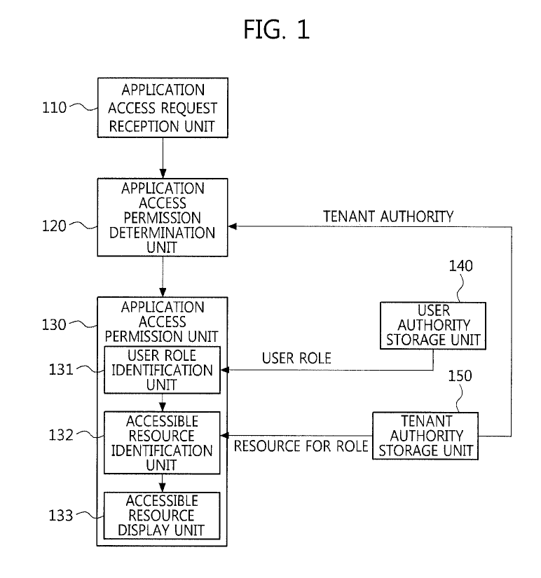

FIG. 1 is a block diagram showing a device for controlling a user's access to an application in accordance with an embodiment of the present invention.

Referring to FIG. 1, an application access control device in accordance with an exemplary embodiment of the present invention includes an application access request reception unit 110, an application access permission determination unit 120, an application access permission unit 130, a user authority storage unit 140, and a tenant authority storage unit 150.

The application access request reception unit 110 receives a request for access to an application (i.e., an application access request) from a user.

The application access permission determination unit 120 determines whether to permit the access by referring to the tenant authority storage unit 150 to identify an access authority of a tenant, to whom the user belongs, with respect to the requested application and to identify whether valid authority information is stored in the tenant authority storage unit 150.

The application access permission unit 130 permits a user, who is permitted to access, to access the requested application. The application access permission unit 130 includes a user role identification unit 131, an accessible resource identification unit 132, and an accessible resource display unit 133.

The user role identification unit 131 identifies the role of the user, who is permitted to access, with respect to the requested application by referring to the user authority storage unit 140.

The accessible resource identification unit 132 identifies accessible resources depending on the role of the user who is permitted to access the requested application by referring to the tenant authority storage unit 150.

The accessible resource display unit 133 displays the identified application resources and resource information to the user to provide a user interface which can be selected by the user.

Next, a user control process for an application access request from a user in accordance with an exemplary embodiment of the present invention will be described.

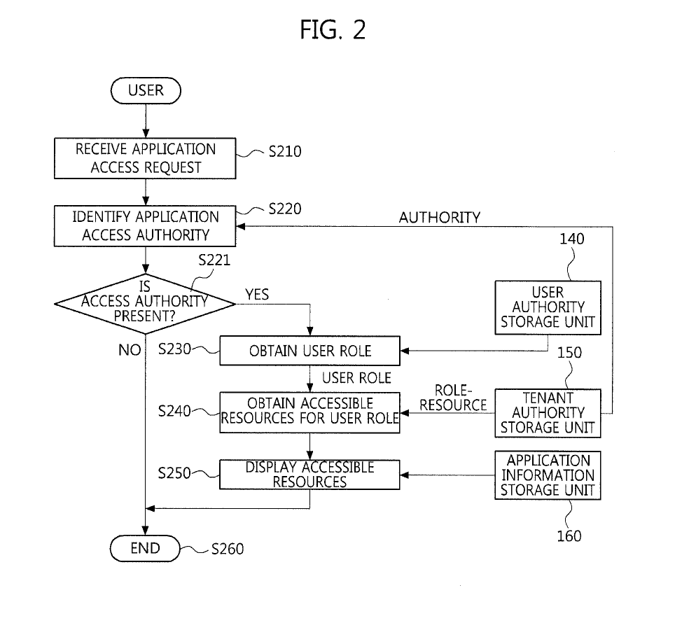

FIG. 2 is a sequence chart showing a process of controlling a user's access to an application in accordance with an exemplary embodiment of the present invention.

Referring to FIG. 2, a process of controlling a user's access to an application includes an application access request receiving step (S210), an application access authority identifying step (S220), a step of obtaining the user's role with respect to the requested application (S230), a step of obtaining an accessible resource depending on the user's role (S240), and an accessible resource display step (S250).

When receiving a request for access to an application access (i.e., an application access request) from a user (S210), it is identified whether the tenant, to whom the user belongs, has an authority to access the requested application by referring to the tenant authority storage unit 150 (S220).

If the tenant to whom the user belongs has no authority to access the corresponding application, the access to the requested application is not permitted and the process is terminated (S260).

If the tenant to whom the user belongs has the access authority, the access to the application is permitted. Here, the following steps are performed to provide a list of accessible resources with respect to the requested application to the user interface.

First, the user's role with respect to the application is obtained by referring to the user authority storage unit 140 (S230). Based on the user's role, the accessible resources according to the obtained user's role are obtained by referring to the tenant authority storage unit 150 (S240).

Then, the user interface with respect to the list of the accessible resources is provided by referring to an application information storage unit 160 (S250).

(2) Configuration and Operation of Access Control Device with Respect to Application Resources

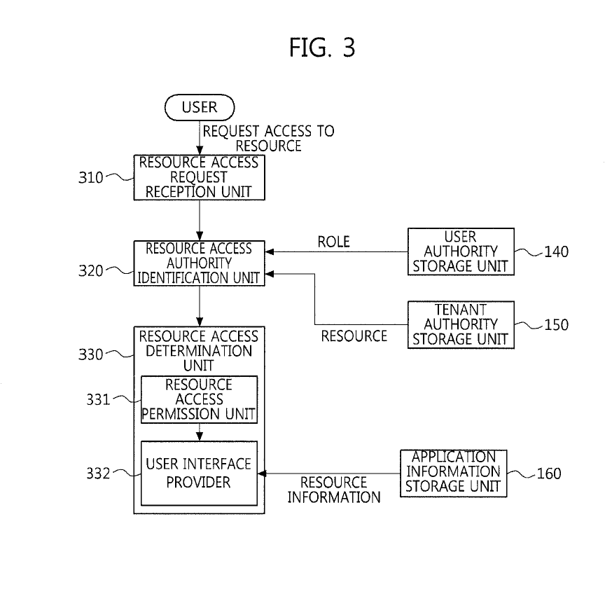

FIG. 3 is a block diagram showing a device for controlling a user's access to an application resource in accordance with an exemplary embodiment of the present invention.

Referring to FIG. 3, a resource access control device in accordance with an exemplary embodiment of the present invention includes a resource access request reception unit 310, a resource access authority identification unit 320, a resource access determination unit 330, a tenant authority storage unit 150, and an application information storage unit 160.

The resource access request reception unit 310 receives a request for access to an application resource (i.e., an application resource access request) from a user.

The resource access authority identification unit 320 identifies whether the user has an authority to access the requested application resource by referring to the user authority storage unit 140 and the tenant authority storage unit 150.

The resource access determination unit 330 determines the access to the requested application resource with respect to the user whose access authority is identified. The resource access determination unit 330 may comprise a resource access permission unit 331 which permits the user permitted to access the resource and a user interface provider 332 which obtains information on the resource from the application information storage unit 160 such that the user, who is permitted to access the resource, can access the resource and provides a user interface to the user.

Next, a user control process with respect to an application resource access request from a user in accordance with an exemplary embodiment of the present invention will be described.

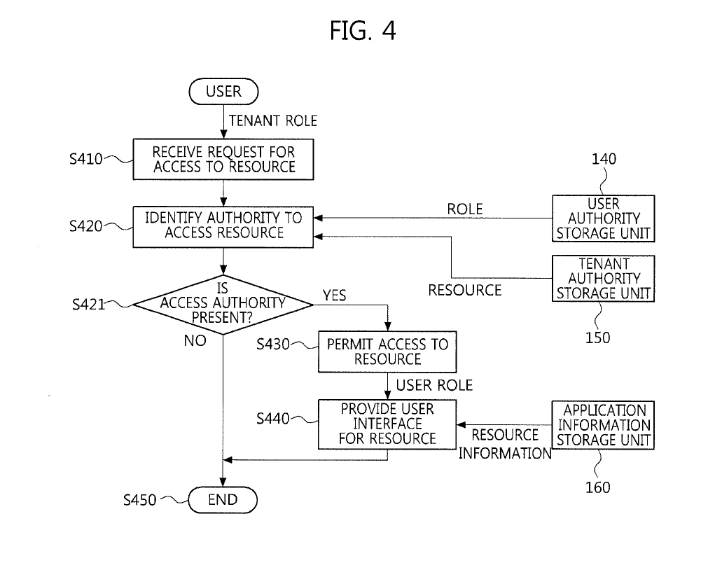

FIG. 4 is a sequence chart showing a process of controlling a user's access to an application resource in accordance with an exemplary embodiment of the present invention.

Referring to FIG. 4, a process of controlling a user's access to an application resource includes a resource access request receiving step (S410), a resource access authority identifying step (S420), a resource access permitting step (S430) and a user interface providing step (S440).

When receiving a request for access to a resource (i.e., a resource access request) from a user (S410), a role of the user is obtained by referring to the user authority storage unit 140, and it is identified whether the requested resource is accessible by the obtained role by referring to the tenant authority storage unit 150 (S420).

If the user requesting the access to the resource has no authority to access the corresponding resource, the access to the requested resource is not permitted and the process is terminated (S450).

If the user has the access authority, the access to the resource is permitted (S430). Here, the information on the requested resource is obtained by referring to the application information storage unit 160 and provided to a user interface (S440).

Regarding the user access control, the application access control and the resource access control have been described with respect to the device and the process separately in the above exemplary embodiments. However, as mentioned above, a device for managing and controlling the users' authority with respect to multiple tenants, which comes within the spirit of the present invention, according to the requirements of each tenant may be configured in various ways depending on the user interfaces provided.

Next, the configuration of a tenant authority storage unit and a user authority storage unit, which constitute the access control device, will be described. Accordingly, an authority definition device with respect to a virtual tenant in which a basic authority for the tenant authority storage unit and the user authority storage unit is predefined will be first described, and then a tenant authority definition device will be described.

Configuration and Operation of Virtual Tenant Authority Definition Device

The configuration and operation of a device for defining a basic authority of a tenant with respect to an application, that is, a device for defining an authority for a virtual tenant, i.e., a kind of template, will be described. The device intends to automatically define an authority to use the application to a tenant based on the authority defined to a virtual tenant at a point of time when an actual tenant requests the use of the application and can be used upon development of the application.

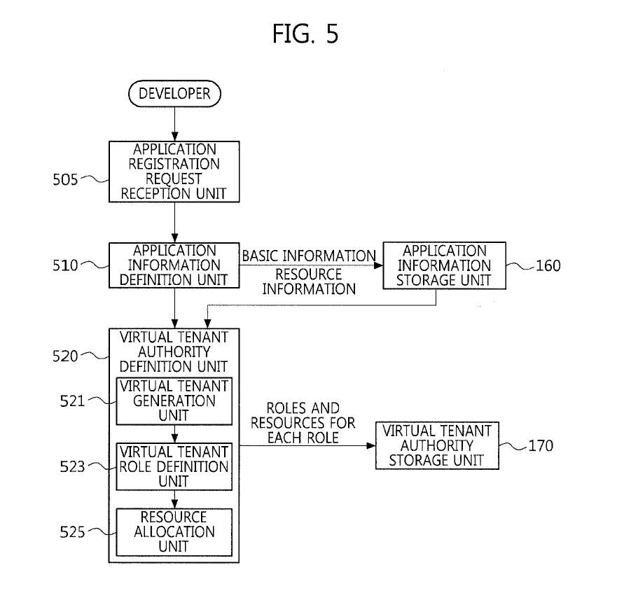

FIG. 5 is a block diagram of a device for defining a virtual tenant authority in accordance with an exemplary embodiment of the present invention.

Referring to FIG. 5, a device for defining a virtual tenant authority includes an application registration request reception unit 505, an application information definition unit 510, a virtual tenant authority definition unit 520, the application information storage unit 160, and a virtual tenant authority storage unit 170.

The application information definition unit 510 receives a request for registration of an application to be provided to a tenant in the SaaS platform from the application registration request reception unit 505 and defines information on the application requested to be registered. That is, the application information definition unit 510 defines basic information and resources which are included in the developed application and stores them in the application information storage unit 160.

For example, when an application such as a groupware is developed and provided to the tenant, the basic information on the groupware and resources belonging to the groupware, i.e., submodules such as an e-mail, board creation, board reference, document preparation, document approval, etc., may be defined as the resources.

The application information storage unit 160 includes, as mentioned above, basic information on the application and information on the resources belonging to the application. A more detailed structure of the application information storage unit 160 will be described later.

The virtual tenant authority definition unit 520 defines one virtual tenant which does not actually exist, allocates the resources of the application, in which the above information is stored, to the one virtual tenant which is defined randomly, and then stores the resources in the virtual tenant authority storage unit 170.

The virtual tenant authority definition unit 520 includes a virtual tenant generation unit 521, a virtual tenant role definition unit 523, and a resource allocation unit 525.

The virtual tenant generation unit 521 generates one virtual tenant with respect to the application whose information is defined.

The virtual tenant role definition unit 523 defines at least one role belonging to the virtual tenant and information on the role. For example, the role may include a role of a user such as a general user, a manager, an operator, etc.

The resource allocation unit 525 defines resources, which belong to the application, related to the role. For example, an e-mail, board reference, document preparation, document approval, etc. may be defined as a manager's role with respect to the groupware application.

The virtual tenant authority storage unit 170 stores the tenant's role with respect to the application and the information on the resources of the application, which are defined by the virtual tenant role definition unit 523 and the resource allocation unit 525, respectively. A more detailed structure of the virtual tenant authority storage unit 170 will be described later.

Next, the structure of the application information storage unit will be described in more detail.

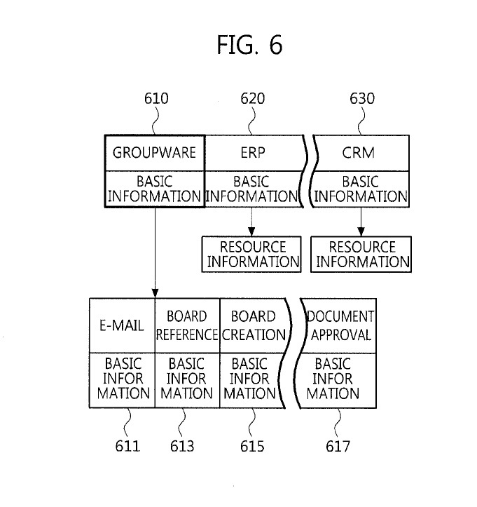

FIG. 6 is a conceptual diagram showing the structure of an application information storage unit in accordance with an exemplary embodiment of the present invention.

Referring to FIG. 6, it can be seen that the application information storage unit 160 includes at least one application 610, 620 and 630, basic information on the applications 610, 620 and 630, at least one resource 611 to 617 related to the applications 610, 620 and 630, and basic information on the resources 611 to 617.

For example, referring to FIG. 6, an application such as a groupware 610 is developed and the basic information on the groupware 610 is defined. Then, at least one resource belonging to the groupware 610 such as an e-mail 611, a board reference 613, a board creation 615, a document approval 617, etc. is defined and stored in the application information storage unit 160.

Subsequently, the structure of the virtual tenant authority storage unit 170 will be described in more detail.

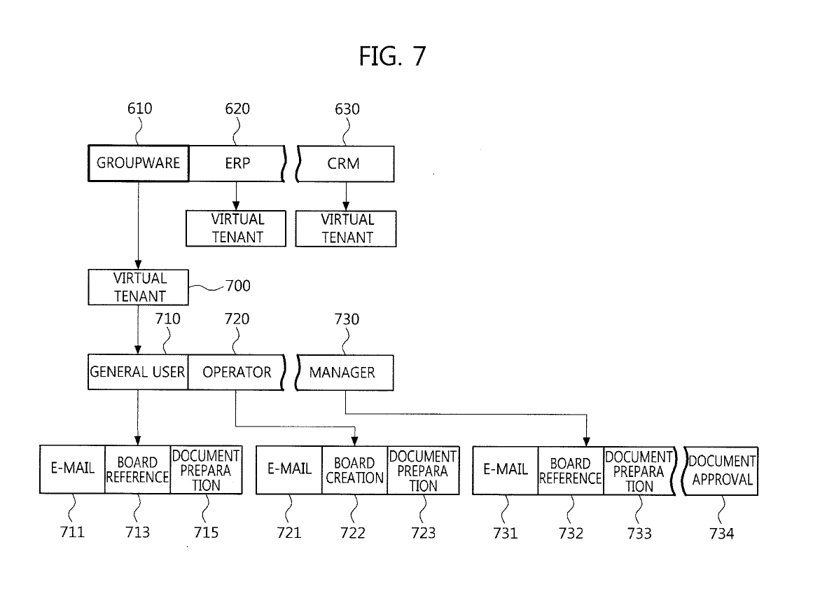

FIG. 7 is a conceptual diagram showing the structure of a virtual tenant authority storage unit in accordance with an exemplary embodiment of the present invention.

Referring to FIG. 7, it can be seen that one virtual tenant 700 with respect to one application 610 is present in the virtual tenant authority storage unit 170 and at least one user's role 710, 720 and 730 related to the virtual tenant 700 is defined therein. Moreover, it can be seen that each of the user's roles 710, 720 and 730 is related to at least one of the resources 711 to 713, 721 to 723, and 731 to 734, respectively.

For example, referring to FIG. 7, the virtual tenant 700 is defined with respect to the application 610 such as a groupware, and a general user 710, an operator 720, and a manager 730 are defined as the user's role with respect to the virtual tenant. Moreover, it can be seen that the resources are allocated differently for each user. For example, an e-mail 711, a board reference 713, and a document preparation 715 are allocated to the general user 710. An e-mail 721, a board creation 722, and a document preparation 723 are allocated to the operator 720. An e-mail 731, a board reference 732, a document preparation 733, and a document approval 734 are allocated to the manager 730.

The aforementioned structure is merely an example for allocating the resources of the application to the virtual tenant, and the structure of the virtual tenant storage unit of the present invention is not limited thereto.

Next, a process of defining a virtual tenant authority in accordance with an exemplary embodiment of the present invention will be described.

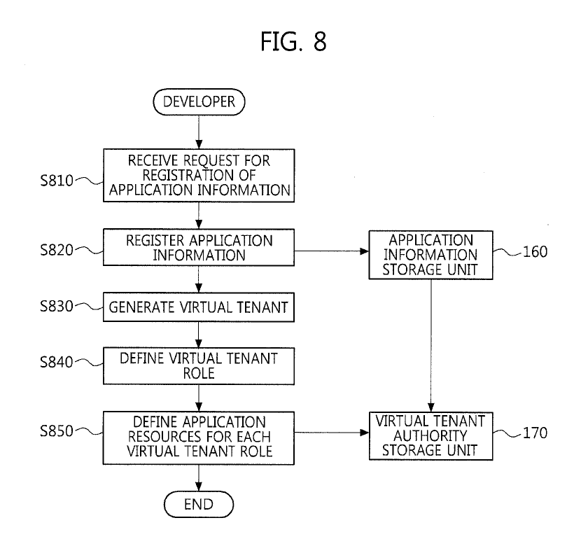

FIG. 8 is a sequence chart showing a process of defining a virtual tenant authority in accordance with an exemplary embodiment of the present invention.

Referring to FIG. 8, a process of defining a virtual tenant authority includes an application information registration request receiving step (S810), an application information registering step (S820), an application-related virtual tenant generation step (S830), a virtual tenant role defining step (S840), and a virtual tenant role-based application resource defining step (S850).

When receiving a request for registration of information on a developed application (S810), basic information on the application and resources belonging to the application are defined and registered in the application information storage unit 160 (S820). Here, at least one resource belonging to the application is included.

Subsequently, a virtual tenant to whom the authority to use of the application is allocated is generated (S830). The reason that the virtual tenant is generated is as follows. A basic role of the virtual tenant is defined, and available resources of the application based on the basic role are defined. Then, when a request for use of the application is received later from an actual tenant, the defined role of the virtual tenant and the resources related to the role are copied as they are to define the authority to use the application of the tenant requesting the use of the application.

Next, as mentioned above, one or more roles related to the generated virtual tenant are defined (S840). For example, the users' roles shown in FIG. 7 may be defined as the above roles. However, the roles are not limited to the users' roles and may be changed according to the type and function of the application.

In the next place, one or more application resources which can be used by the defined role of the virtual tenant are defined (S850), thereby allocating the authority to use the resource for each role.

Through the above-described steps S810 to S850, the resources which are accessible by each role of the virtual tenant with respect to the application are defined and stored in the virtual tenant authority storage unit 170.

Next, the configuration of the tenant authority definition device configured to define the authority of the tenant based on the virtual tenant authority definition unit will be described.

Configuration and Operation of Application Use Request Tenant Authority Definition Device

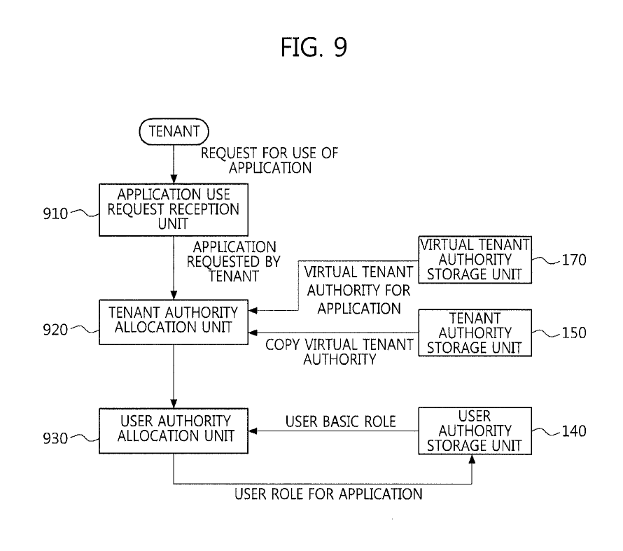

FIG. 9 is a block diagram showing a tenant authority definition device for defining an authority of a tenant requesting the use of an application in accordance with an exemplary embodiment of the present invention.

Referring to FIG. 9, a tenant authority definition device for defining an authority of a tenant requesting the use of an application in accordance with the exemplary embodiment of the present invention includes an application use request reception unit 910, a tenant authority allocation unit 920, a user authority allocation unit 930, a tenant authority storage unit 150, and a user authority storage unit 140.

The application use request reception unit 910 receives a request for use of an application from a tenant. The tenant may be a new tenant or a tenant which has used another application.

The tenant authority allocation unit 920 receives information of the tenant requesting the use of the application and information on the requested application from the application use request reception unit 910, copies the authority information of the virtual tenant stored in the virtual tenant authority storage unit 170 to the authority information of the tenant requesting the use of the application, and stores it in the tenant authority storage unit 150.

The tenant authority storage unit 150 stores, as mentioned above, the authority information of the tenant requesting the use of the application. A more detailed structure of the tenant authority storage unit 150 will be described later.

The user authority allocation unit 930 allocates the roles of users with respect to the requested application based on the basic roles of the users belonging to the tenant requesting the use of the application, stored in the user authority storage unit 140, and stores the allocated roles in the user authority storage unit 140. When a user requests an access to the application and resources, the stored users' roles are referred to determine whether to permit the access.

As mentioned above, the user authority storage unit 140 stores the authority information of the users belonging to the tenant requesting the use of the application. A more detailed structure of the user authority storage unit 140 will be described later.

Next, the structure of the tenant authority storage unit 150 will be described in more detail.

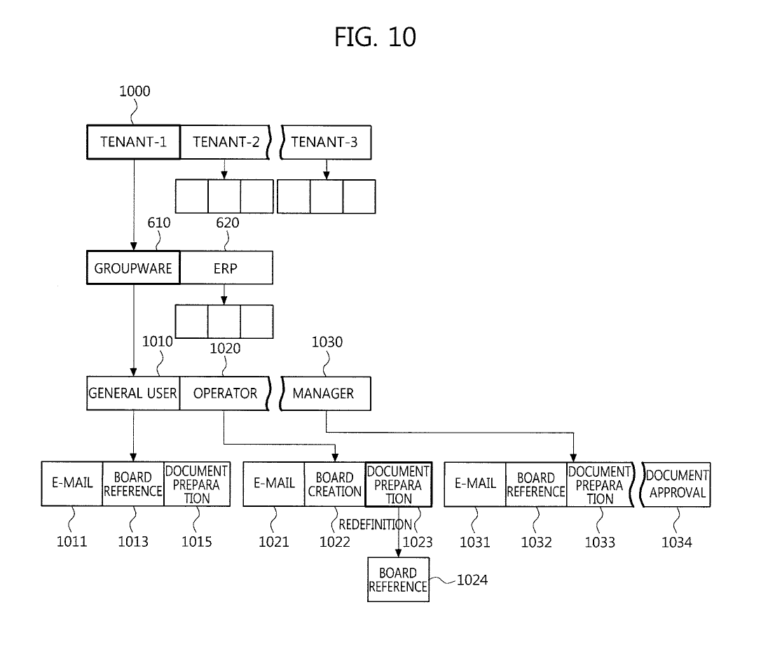

FIG. 10 is a conceptual diagram showing the structure of a tenant authority storage unit in accordance with an exemplary embodiment of the present invention.

Referring to FIG. 10, it can be seen that applications related to at least one tenant and resources based on the roles are defined in the tenant authority storage unit 150.

Referring to FIG. 10, a tenant-1 1000 uses applications such as a groupware 610 and an ERP 620, for example. In the case of the groupware 610, it can be seen that a general user 1010, an operator 1020, and a manager 1030 are defined as the related roles. It can also be seen that the resources of the application groupware 610 are allocated with respect to each of the users' roles.

That is, an e-mail 1011, a board reference 1013, and a document preparation 1015 are allocated to the general user 1010. An e-mail 1021, a board creation 1022, and a document preparation 1023 are allocated to the operator 1020. An e-mail 1031, a board reference 1032, a document preparation 1033, and a document approval 1034 are allocated to the manager 1030.

Referring to FIGS. 7 and 10, it can be understood that the tenant authority including the resources allocated for each role, as shown in the example of the structure of the virtual tenant of FIG. 8, copies the authority information on the groupware of the virtual tenant as it is, and stores it in the tenant authority storage unit.

However, the copied authority information can be redefined. For example, the document preparation 1023 allocated to the operator 1020 may be deleted and a board reference 1024 may be redefined and allocated to the operator 1020.

Next, the structure of the user authority storage unit 140 will be described in more detail.

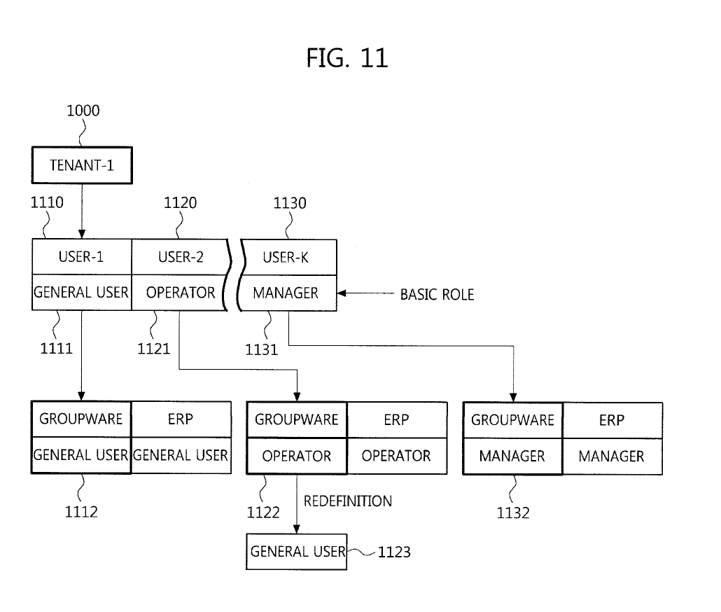

FIG. 11 is a conceptual diagram showing the structure of a user authority storage unit in accordance with an exemplary embodiment of the present invention.

Referring to FIG. 11, it can be seen that basic roles 1111, 1121 and 1131 of users 1110, 1120 and 1130 belonging to the tenant requesting the use of the application and users' roles 1112, 1122 and 1132 with respect to the requested application are defined in the user authority storage unit 140.

That is, as mentioned above, the users' roles 1112, 1122 and 1132 with respect to the requested application are determined in the same manner as the basic roles 1111, 1121 and 1131 of the users predefined by the user authority allocation unit 930. However, the roles 1112, 1122 and 1132 may be differently determined for each application, and thus the roles may be changed by a redefinition process. For example, while the basic role of user-2 1120 is determined as the operator 1121, it may be redefined as a general user 1123 in the groupware whose role is not the operator.

Next, a process of defining an authority to use an application with respect to a tenant requesting the use of the application in accordance with the exemplary embodiment of the present invention will be described.

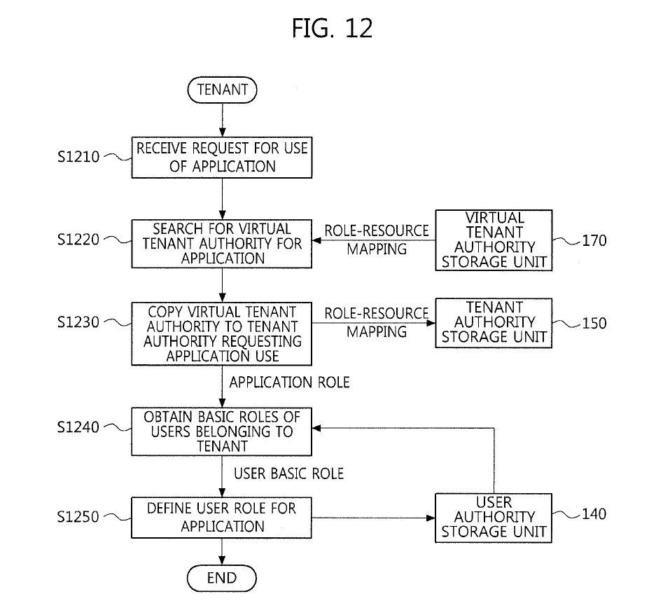

FIG. 12 is a sequence chart showing a process of defining a tenant's authority to use an application in accordance with an exemplary embodiment of the present invention.

Referring to FIG. 12, a process of defining an authority to use an application with respect to a tenant requesting the use of the application includes a step of receiving a request for use of an application (i.e., an application use request) from a tenant (S1210), a step of searching for a virtual tenant authority with respect to the requested application (S1220), a step of copying the searched virtual tenant authority to the authority of the tenant requesting the use of the application (S1230), a step of obtaining basic roles of users belonging to the tenant requesting the use of the application (S1240), and a step of defining a user role with respect to the application (S1250).

When a request for use of an application is received from a tenant (S1210), the virtual tenant authority registered in the virtual tenant authority storage unit 170 with respect to the requested application is searched (S1220). The virtual tenant authority includes resources allocated for each role with respect to the requested application.

Then, the searched virtual tenant authority is copied to the authority of the tenant requesting the use of the application (S1230). That is, the roles and the resource information for each role, which are defined in the virtual tenant with respect to the requested application, are copied as they are to the authority information of the tenant requesting the use of the application and stored in the tenant authority storage unit 150. When it is necessary to correct the resource for each role defined in the virtual tenant, only the necessary part may be redefined.

In the next place, a step of defining a user authority is performed. First, a basic role of the user belonging to the tenant requesting the use of the application is obtained (S1240), defined as a user role with respect to the requested application, and then stored in the user authority storage unit 140 (S1250).

When an access to the requested application or the resource is requested, the user authority defined in the above manner may be referred to control the user authority.

As described above, according to the authorization management apparatus and method in a software-as-a-service (SaaS) platform of the present invention, when the functions of the application are allocated to each enterprise, it is possible to simplify the process of allocating the authority to users of each enterprise and customize the roles and authority for each enterprise based on the basic authority allocated to a virtual tenant with respect to the application, thereby reducing the errors and time loss due to manual operation.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. An application access control device for a software-as-a-service (SaaS), the device comprising:
an application access request reception unit which receives a request for access to an application from a user belonging to one tenant;
a tenant authority storage unit in which a tenant authority for an application is defined, the tenant authority including roles and resources accessible for each role;
an access permission determination unit which determines whether to permit the access by referring to the tenant authority storage unit to identify an authority of the tenant, to whom the user requesting the access to the application belongs, with respect to the requested application;
a user authority storage unit which stores authority information including the roles of users belonging to each tenant with respect to the application; and
an access permission unit which permits the user, who is permitted to access, to access the requested application by referring to the user authority storage unit.

2. The application access control device of claim 1, wherein the access permission unit comprises:
a role identification unit which identifies the role of the user, who is permitted to access the requested application, by referring to the user authority storage unit;
an accessible resource identification unit which identify accessible resources based on the identified role of the user by referring to the tenant authority storage unit; and
a resource display unit which displays a list of the identified accessible resources through a user interface.

3. A resource access control device for a software-as-a-service (SaaS), the device comprising:
a resource access request reception unit which receives a request for access to an application resource from a user belonging to one tenant;
a user authority storage unit which stores authority information including roles of users belonging to each tenant with respect to the application;
a tenant authority storage unit in which a tenant authority for the application is defined, the tenant authority including roles and resources accessible for each role;
a resource access authority identification unit which identifies whether the user has an authority to access the requested application resource by referring to the user authority storage unit and the tenant authority storage unit; and
a resource access determination unit which determines the access to the requested resource with respect to the user whose access authority is identified.

4. The resource access control device of claim 3, wherein the resource access determination unit comprises:
an application information storage unit which stores basic information on the application and information on at least one resource belonging to the application;
a resource access permission unit which permits the user, whose access authority is identified, to access the resource; and
a user interface provider which obtains information on the resource requested to be accessed by referring to the application information storage unit and provides an interface to the user who is permitted to access the resource.

5. A virtual tenant authority definition device for a software-as-a-service (SaaS), the device comprising:
an application registration request reception unit which receives a request for registration of an application to be provided to a tenant;
an application information storage unit which stores information on the application;
a virtual tenant authority storage unit which stores information on a virtual tenant's authority to use the application;
an application information definition unit which defines information on the application requested to be registered and stores the defined information in the application information storage unit; and
a virtual tenant authority definition unit which allocates an authority to use the application, whose information is defined, to the virtual tenant and stores the authority to use the application in the virtual tenant authority storage unit.

6. The virtual tenant authority definition device of claim 5, wherein the application information stored in the application information storage unit comprises basic information on the application, at least one application resource belonging to the application, and basic information on the application resource.

7. The virtual tenant authority definition device of claim 6, wherein the virtual tenant’ authority to use the application, stored in the virtual tenant authority storage unit, comprises at least one role, which belongs to the virtual tenant, with respect to the application whose information is defined and at least one resource accessible by the role.

8. The virtual tenant authority definition device of claim 7, wherein the virtual tenant authority definition unit comprises:
a virtual tenant generation unit which generates any virtual tenant to give a basic authority to the application whose information is defined;
a role definition unit which defines at least one role belonging to the generated virtual tenant and stores the defined role in the virtual tenant authority storage unit; and
a resource allocation unit which defines at least one resource belonging to the application whose information is defined such that the resource is accessible by the defined role and stores the defined resource in the virtual tenant authority storage unit.

9. A tenant authority definition device for a software-as-a-service (SaaS), the device comprising:
an application use request reception unit which receives a request for use of an application from a tenant;
a virtual tenant authority storage unit which stores authority information of a virtual tenant with respect to the application;
a tenant authority storage unit which stores authority information of the tenant requesting the use of the application; and
a tenant authority allocation unit which copies the authority information of the virtual tenant, which is stored in the virtual tenant authority storage unit, with respect to the requested application as authority information of the tenant requesting the use of the application and stores the authority information in the tenant authority storage unit.

10. The tenant authority definition device of claim 9, further comprising:
a user authority storage unit which stores authority information of users belonging to the tenant requesting the use of the application; and
a user authority allocation unit which refers to the authority information of the tenant requesting the use of the application and the authority information of the users stored in the user authority storage unit and allocates an authority to use the requested application to the users belonging to the tenant requesting the use of the application.

11. The tenant authority definition device of claim 10, wherein the authority information of the virtual tenant stored in the virtual tenant authority storage unit comprises at least one role, which belongs to the virtual tenant, with respect to the application requested to be used and at least one resource accessible by the role,
wherein the authority information of the tenant requesting the use of the application stored in the tenant authority storage unit comprises at least one role, which belongs to the tenant requesting the use of the application, with respect to the application requested to be used and at least one resource accessible by the role, and
wherein the authority information of the user stored in the user authority storage unit comprises information defining basic roles of the users belonging to the tenant requesting the use of the application and a role of the requested application.

12. The tenant authority definition device of claim 11, wherein the user authority allocation unit defines the roles of the users with respect to the requested application based on the basic roles of the users belonging to the tenant requesting the use of the application stored in the user authority storage unit and stores the defined roles in the user authority storage unit.

13. The tenant authority definition device of claim 12, wherein the roles of the users with respect to the requested application can be redefined differently.

14. The tenant authority definition device of claim 9, wherein the authority information of the virtual tenant copied to the tenant authority storage unit can be redefined.

15. A method of defining a virtual tenant authority implemented by a virtual tenant authority definition device for a software-as-a-service (SaaS), the method comprising:
receiving a request for registration of an application to be provided to a tenant;
defining information on the application requested to be registered; and
allocating an authority to use the application, whose information is defined, to a virtual tenant.

16. The method of claim 15, wherein the application information comprises basic information on the application, at least one application resource belonging to the application, and basic information on the application resource.

17. The method of claim 16, wherein the virtual tenant’ authority to use the application comprises at least one role, which belongs to the virtual tenant, with respect to the application whose information is defined and at least one resource accessible by the role.

18. A method of defining a tenant authority implemented by a tenant authority definition device for a software-as-a-service (SaaS), the method comprising:
receiving a request for use of an application from a tenant;
allocating predefined authority information of a virtual tenant to authority information of the tenant requesting the use of the application as it is; and
allocating an authority to use the requested application to users belonging to the tenant requesting the use of the application by referring to the allocated authority information of the tenant requesting the use of the application and information of the users belonging to the tenant requesting the use of the application.
